(19) United States
(12) Patent Application Publication
(10) Pub. No.: US 2008/0022858 A1
(43) Pub. Date: Jan. 31, 2008

(54) Beverage freshness indicator

(76) Inventor: Jan Murtagh, Portland, OR (US)

Correspondence Address: KOLISCH HARTWELL, P.C., 520 SW YAMHILL STREET, Suite 200, PORTLAND, OR, 97204, US

(21) Appl. No.: 11/496,758

(22) Filed: Jul. 31, 2006

(51) Int. Cl. A47J 31/06

(52) U.S. Cl. 99/285

(57) ABSTRACT

A system for use in specifying freshness of a beverage within a beverage container. The system includes a resilient filament configured for selected attachment to the beverage container. The system also includes a timing device secured to the resilient filament. The timing device includes a user interface configured to indicate freshness of the beverage within the beverage container based on an elapsed time.

### TECHNICAL FIELD

This invention relates generally to beverages, and more particularly to systems for use in indicating the freshness of a beverage in a beverage container.

### BACKGROUND OF THE INVENTION

Beverages, like other consumables, often have life-spans of which the beverage is considered to be fresh and consumable following being opened, brewed, mixed, etc. For example, coffee becomes bitter and distasteful after a certain amount of time following brewing. In restaurants, cafes, and convenient stores, coffee is often brewed into a carafe, and the carafe is then often placed on a hot plate to keep the coffee warm. Such work environments are often hectic, and staff often forget how long it has been since a given coffee carafe was brewed. Unfortunately, customers are then served the bitter and distasteful coffee when they would much prefer fresh-brewed coffee.

Currently, staff can then determine how much time has passed since brewing a beverage by referencing a clock or a watch, and may use such elapsed time to determine freshness of the brewed beverage. However, staff may forget to check the time, or may incorrectly recall the time. When it is actually time to dispose of the non-fresh coffee, staff may neglect to notice the elapsed time. Even if staff does notice the elapsed time, staff may choose to ignore it, assuming, that their recollection is flawed. As a result, it is difficult to ensure that customers will receive coffee while it is still fresh.

As coffee is becoming increasingly popular, and is being served in an increasing variety of locales, consumers are demanding higher standards. To this end, restaurants, cafes, convenient stores, and other settings are increasingly including quality control in their coffee preparation and service. Thus, it is desirable to provide a system that attaches to a coffee carafe, keeps track of the time elapsed since brewing a carafe of coffee, and noticeably indicates to the staff the appropriate time to discard non-fresh coffee and brew a fresh carafe of coffee.

### SUMMARY OF THE INVENTION

A system is provided for use in specifying freshness of a beverage within a beverage container. The system includes a resilient filament configured for selected attachment to the beverage container. The system also includes a timing device secured to the resilient filament. The timing device includes a user interface configured to indicate freshness of the beverage within the beverage container based on an elapsed time.

### BRIEF DESCRIPTION OF THE DRAWINGS

FIG. 1 is a perspective view of a beverage freshness indicator system according to an embodiment of the present invention, the freshness indicator system being installed on a coffee carafe of somewhat conventional design.

FIG. 2 is a perspective view of a timing device forming a part of the beverage freshness indicator system of claim 1, showing a front detail.

FIG. 3 is a perspective view of the timing device of FIGS. 1 and 2, but showing a rear detail.

FIG. 4 is a top view of the beverage freshness indicator system of FIG. 1, the system being shown in various orientations relative to a receiving portion of a beverage container, shown in dashed lines, to demonstrate alternative attachment arrangements to a beverage container.

FIG. 5 is a partial cross-sectional side view of the freshness indicator system of FIGS. 1-4, the view being taken along lines 5-5 of FIG. 4 to illustrate attachment of the timing device to a resilient connector, and illustrating relative movement between the timing device and the resilient connector in dashed lines.

FIG. 6 is a perspective view of a beverage freshness indicator system according to another embodiment of the present invention.

### DETAILED DESCRIPTION OF THE PREFERRED EMBODIMENTS

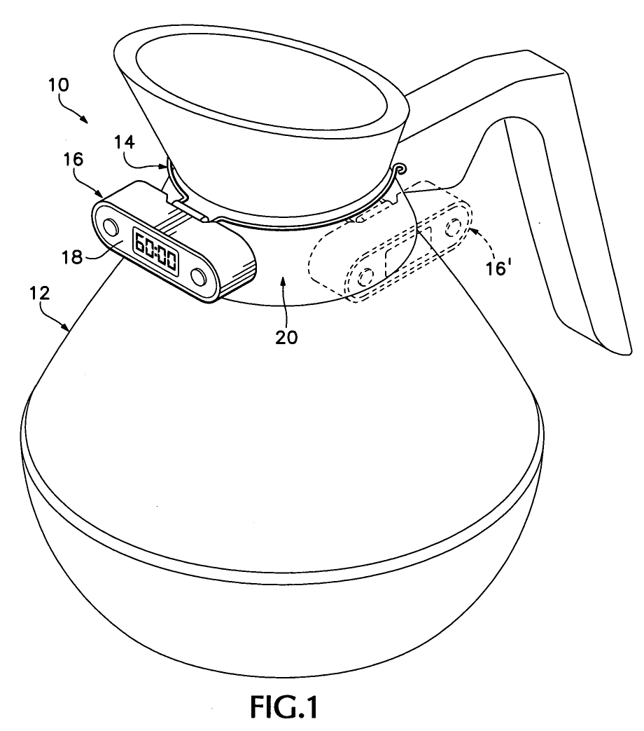

Referring initially to FIG. 1, an exemplary beverage freshness indicator system is shown at 10, the system being designed to resiliently attach to a beverage container 12 in the form of a coffee carafe. As indicated, system 10 includes a connector 14 and a timing device 16. Connector 14 may take the form of a resilient filament and may be configured for selected attachment to beverage container 12. Timing device 16 may be secured to the connector such that attachment of the connector to the beverage container attaches the timing device to the beverage container. The timing device 16 may include a user interface 18, which may indicate freshness of a beverage within the beverage container 12 based on an elapsed time. While beverage container 12 is depicted as a coffee carafe, and system 10 is configured to specifically accommodate attachment to such a coffee carafe, it will be appreciated that system 10 is representative of a variety of embodiments, and that changes in form may be made to accommodate use with a variety of different beverage containers.

As shown in FIGS. 1 and 4, connector 14 is configured to retain system 10 about a receiving portion 20 of beverage container 12. Connector 14 may be configured to at least partially surround receiving portion 20, thereby attaching system 10 to the beverage container. In FIG. 1, where the receiving portion 20 takes the form of an arcuate neck of a carafe, connector 14 may be configured with a similarly arcuate shape and may be biased into a seated position on the neck of the carafe. As indicated, the connector may take the form of a metal wire, or other resilient filament suited to providing a spring-clip effect.

Referring now to FIGS. 1 and 4, it will be noted that system 10 is attachable to the beverage container in a plurality of different positions (typically about the neck of the beverage container) so as to accommodate different container configurations and settings. For example, in a commercial restaurant setting, coffeemakers, or warming plates, may be placed at the end of a counter abutting a wall. In such a setting, it may be appropriate to mount system 10 with the timing device in a position facing 90 degrees from the container handle (indicated as 16′ in FIG. 1). Such a position would allow a user to view user interface 18 without having to remove or rotate the beverage container from a position of natural placement in the coffeemaker (or on the warming plate).

As shown best in FIG. 4, connector 14 may include a projecting mount 22 configured to accommodate securement of the timing device to connector 14. Where the connector is a resilient filament, as in the illustrated embodiment, the projecting mount may take the form of a jog in the filament which provides an attachment portion spaced from the beverage container. Timing device 16 thus may be secured to the attachment portion of projecting mount 22 such that timing device 16 is spaced from the beverage container.

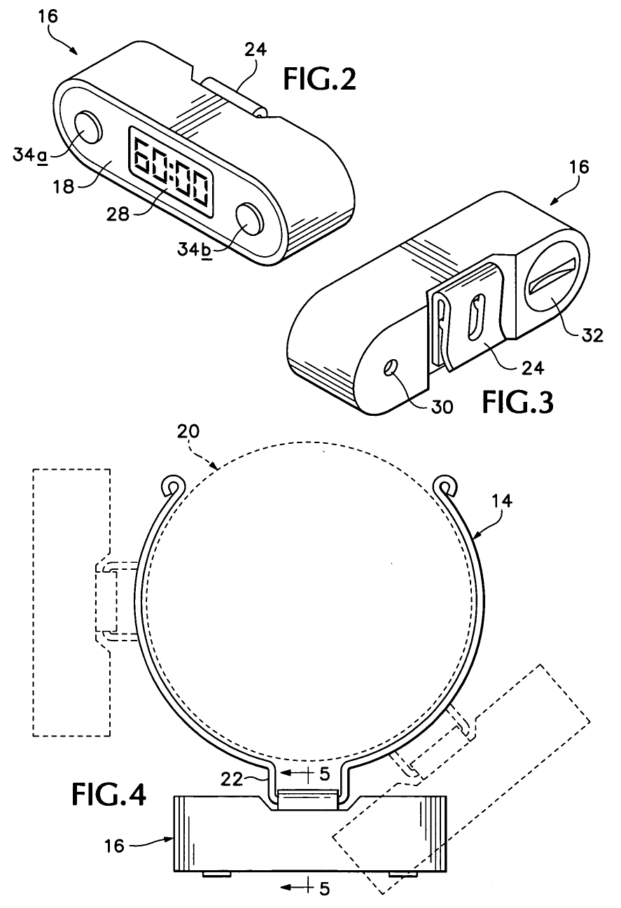

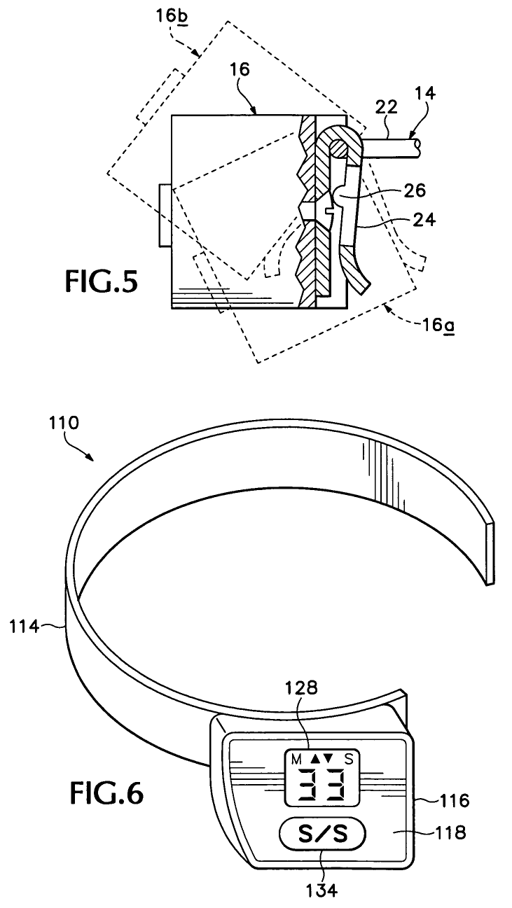

Referring now to FIGS. 2, 3, and 5, it will be appreciated that timing device 16 may employ a clip 24 configured to secure the timing device 16 to the connector 14. As shown in FIG. 4, in embodiments where the connector 14 is a resilient filament with a projecting mount 22, clip 24 may be configured with a filament seat (best shown in FIGS. 3 and 5). In a depicted embodiment, clip 24 is a spring clip. Clip 24 may include a semi-cylindrical protrusion 26 directed inward from the inside surface of clip 24 (as shown in FIG. 5) to define the filament seat.

As shown in FIG. 5, clip 24 may be pivotally adjustable on the resilient filament to accommodate placement of the timing device in different orientations. Users of the system thus may adjust the angle of timing device 16 to be in a position most visible to the user. For example, in a restaurant setting, coffee carafe warming plates have two levels. Therefore, it is desirable to be able to adjust timing device 16 to accommodate placement of a carafe on the upper level such that it is easily viewed from below (as shown in dashed lines at 16a in FIG. 5). Similarly, it is desirable to be able to adjust timing device 16 to accommodate placement of a carafe on a lower level (as shown in dashed lines at 16b in FIG. 5).

Turning now to FIG. 2, it will be noted that user interface 18 of timing device 16 may include a visual display 28 configured to indicate freshness of a beverage within beverage container 12. Visual display 28 may take the form of a digital display, indicating minutes and seconds. The visual display may be capable of displaying elapsed time (counting up to an indication of not-fresh), and/or may be capable of displaying time remaining (counting down to an indication of not-fresh). Although an LCD-type display is illustrated, visual display 28 may take other forms, including forms capable of indicating either elapsed time or time remaining, or forms merely indicating fresh/non-fresh. For example, visual display 28 may take the form of two LEDs—one green LED indicating a condition of fresh, and one red LED indicating a condition of not-fresh. Visual display 28 also may take the form of an analog display. For example, visual display 28 may include a dial with a needle indicating time remaining or elapsed time.

An indication of not-fresh may take the form of any visible or audible indication or signal or a combination of the two. For example, where visual display 28 displays time remaining, visual display 28 may blink <00:00> as an indication of not-fresh. Where visual display 28 displays elapsed time, visual display 28 may blink <20:00> or other appropriate time indicative of the freshness life of the beverage as an indication of not-fresh. In some embodiments, an indication of not-fresh may include an audible indication such as an audible alarm. In such embodiments, timing device 16 may include a speaker 30 as shown in FIG. 3.

Timing device 16 may include internal components capable of operating the visual display and/or audible alarm. For example, timing device may include electronic circuitry capable of controlling the digital display. Timing device 16 also may include a power source for the internal circuitry, the visual display, and the audible alarm. In such embodiments, timing device 16 may include a battery and battery access 32 (as shown in FIG. 3) whereby the battery may be replaced.

Timing device 16 may include an actuator 34a configured to selectively initiate counting by the timing device. Timing device 16 also may include a reset 34b configured to reset counting by the timing device. As shown in FIG. 2, the actuator and reset may take the form of buttons on the user interface. The actuator and reset features may share the same user engagable button. In such embodiments, a user may press the button a first time to start the timer, a second time to stop the timer, and a third time to reset the timer. In other embodiments, the timing device may not be capable of stopping the timer or resetting the timer until an indication of “not fresh” has occurred. Such a function may ensure that the timing device is not accidentally reset during timing and thus providing a false indication of fresh.

Timing device 16 may also include a mode selector. The mode selector may take the form of a button selectively engagable by a user. The mode selector may be configured to select between a count-up timing mode and a count-down timing mode. In addition, the mode selector may be configured to turn on/off an audible indicator, change the length of time before an indication of “not-fresh”, or may be configured to control any other administrative functions of timing device 16.

Referring now to FIG. 6, another exemplary beverage freshness indicator system is shown at 110, the system being designed to resiliently attach to a beverage container. As indicated, system 110 may include a connector 114 and a timing device 116. Connector 114 may take the form of a resilient strap, or other connector structure configured for selective attachment to a beverage container. Timing device 116 may be integral to connector 114, such that attachment of the connector to a beverage container attaches the timing device to the beverage container.

Timing device 116 may employ a user interface 118, which may indicate freshness of a beverage within the beverage container based on an elapsed time. The user interface may include a visual display 128 configured to indicate freshness of a beverage within a beverage container. In the depicted embodiment, the visual display takes the form of a digital display, indicating elapsed time (counting up to an indication of not-fresh) or time remaining (counting down to an indication of not-fresh).

The display may indicate time in minutes and/or seconds, and may indicate whether minutes or seconds are currently being displayed. In the depicted embodiment, an “M” in the upper left-hand corner of the display screen indicates that the timer is counting minutes. The “▴” (up arrow) indicates that the timer is operating as a count-up timer (e.g., counting elapsed time up to an indication of “not fresh”). Similarly, an “S” may be displayed to indicate counting of seconds, and/or a “▾” (down arrow) may be displayed to indicate that the timer is operating as a count-down timer (e.g., counting time remaining down to an indication of “not fresh”).

Typically, where the timer is operating as a count-down timer, the display screen will display a minute count until the final minute, and then will count down in seconds to an indication of “not fresh”. Furthermore, various visual or audible alarms may be provided at various stages during a given timing cycle to alert the operator to the current status of the timer. For example, an audible alarm may sound when a count-down timer changes from a minute count to a second count, and again, when the count-down time has fully elapsed.

An actuator 134 may be configured to selectively initiate counting by the timing device. Actuator 134 may take the form of a user engagable button, and may further be configured to stop and/or reset counting by the timing device. Another button (not shown) may be employed to select between count-up and count-down functionality, and/or to set the timing duration. In some embodiments, such as the embodiment illustrated in FIG. 6, the timing duration and count-up/count-down functionality may be preset by the manufacturer, and is not alterable by the user under normal operation.

While the invention has been disclosed in its preferred form, the specific embodiments thereof as disclosed and illustrated herein are not to be considered in a limiting sense as numerous variations are possible. The subject matter of the invention is regarded to include all novel and non-obvious combinations and subcombinations of the various elements, features, functions and/or properties disclosed herein. No single feature, function, element or property of the disclosed embodiments is essential. The following claims define certain combinations and subcombinations which are regarded as novel and non-obvious. Other combinations and subcombinations of features, functions, elements and/or properties may be claimed through amendment of the present claims or presentation of new claims in this or a related application. Such claims are also regarded as included within the subject matter of applicant's invention irrespective of whether they are broader, narrower, or equal in scope to the original claims.

What is claimed is:

1. A system for use in specifying freshness of a beverage within a beverage container, the system comprising:
a resilient filament configured for selected attachment to the beverage container; and
a timing device secured to the resilient filament, the timing device including a user interface configured to indicate freshness of the beverage within the beverage container based on an elapsed time.

2. The system of claim 1, wherein the resilient filament is selectively configurable to at least partially surround a receiving portion of the beverage container.

3. The system of claim 1, wherein the beverage container is a carafe having an arcuate neck, the resilient filament being configured for attachment to the arcuate neck to retain the timing device on the carafe.

4. The system of claim 1, wherein the resilient filament is attachable to the beverage container in plural positions to accommodate placement of the timing device in different positions relative to the beverage container.

5. The system of claim 1, wherein the timing device further includes a clip configured to secure the timing device to the resilient filament.

6. The system of claim 5, wherein the clip is a spring clip.

7. The system of claim 5, wherein the clip is pivotally adjustable on the resilient filament to accommodate placement of the timing device in different orientations.

8. The system of claim 1, wherein the resilient filament includes a projecting mount, the timing device being secured to the projecting mount such that the timing device is spaced from the beverage container.

9. The system of claim 1, wherein the timing device counts elapsed time up to an indication of not-fresh.

10. The system of claim 1, wherein the user interface includes a visual display.

11. The system of claim 10, wherein the visual display provides an indication of not-fresh.

12. The system of claim 10, wherein the visual display indicates elapsed time.

13. The system of claim 10, wherein the visual display indicates time remaining to an indication of not-fresh.

14. The system of claim 1, wherein the user interface includes an audible alarm.

15. The system of claim 14, wherein the audible alarm provides an indication of not-fresh.

16. The system of claim 1, wherein the timing device further includes an actuator configured to selectively initiate counting by the timing device.

17. The system of claim 1, wherein the timing device further includes a reset configured to reset counting by the timing device.

18. The system of claim 1, wherein the timing device further includes a mode selector configured to select between count-up timing and count-down timing by the timing device.

19. A freshness indicator for use with a beverage carafe, the freshness indicator comprising:
a connector configured for removable attachment to a neck of the beverage carafe; and
a timer secured to the connector, the timer including a display configured to indicate a time count and an alarm configured to produce a signal upon elapse of a predetermined freshness count indicative of freshness of a beverage within the beverage carafe.

20. The freshness indicator of claim 19, wherein the timer further includes an actuator configured to selectively initiate counting by the timer and a reset configured to selectively reset timer count.
